(19) United States
(12) Patent Application Publication
(10) Pub. No.: US 2008/0158016 A1
(43) Pub. Date: Jul. 3, 2008

(54) System and method for obtaining location of public transportation vehicles using personal handy-phone system

(75) Inventors: Daniel Daping Wang, Qingdao (CN); Feng Xu, Qingdao (CN)

Correspondence Address: HARNESS, DICKEY & PIERCE, P.L.C., P.O. BOX 8910, RESTON, VA, 20195, US

(73) Assignee: LUCENT TECHNOLOGIES INC

(21) Appl. No.: 11/802,480

(22) Filed: May 23, 2007

(30) Foreign Application Priority Data
Dec. 29, 2006 (CN) 200610064476.7

(51) Int. Cl. G08G 1/123; G06F 19/00

(52) U.S. Cl. 340/993

(57) ABSTRACT

In one embodiment, the method for obtaining location of a public transportation vehicle using a personal handy-phone (PHS) system includes receiving a location request identifying a public transportation vehicle and determining an arrival destination associated with the location request. A response to the location request is generated based on the identified public transportation vehicle and the determined arrival destination. The response may include at least one of a current location of the public transportation vehicle, an estimated time of arrival of the public transportation vehicle at the determined arrival destination, a direction the public transportation vehicle is traveling, and stops of the public transportation vehicle on a route of the public transportation vehicle which are adjacent to the determined arrival destination.

### PRIORITY STATEMENT

This non-provisional U.S. patent application claims priority under 35 U.S.C. §119 to Chinese Patent Application No. 200610064476.7, filed on Dec. 29, 2006, the entire contents of which is incorporated herein by reference.

### BACKGROUND

1. Field of the Invention

The present invention is related to a system and method for telecommunications. More particularly, the present invention relates to a system and method for obtaining the location of public transportation vehicles using a personal handy-phone system (PHS).

2. Background Information

A large amount of people use public transportation. However, one of the drawbacks of public transportation is waiting for the arrival of the public transportation vehicle. For example, a bus may not arrive at a bus stop at the scheduled time for various reasons including traffic delays, engine trouble, etc.

Public transportation systems have attempted to address this drawback by installing conventional tracking systems at primary locations on the public transportation route. For example, some bus stations now include tracking systems, which provide information regarding incoming and outgoing buses at the bus stop.

These conventional tracking systems may be implemented using various conventional methods and technologies to detect the position of a public transportation vehicle. Examples of such methods and technologies include an Automatic Vehicle Monitoring System (AVM) and a Global Positioning System (GPS).

However, the information provided by these conventional tracking systems is only available at the bus station. Accordingly, while the conventional tracking systems may inform the commuter once the commuter is at the station. This commuter has no way of knowing that the public transportation vehicle is or will be late until the commuter is at the station, which means the commuter will not be able to reduce the time spent waiting for the arrival of the public transportation vehicle.

### SUMMARY OF THE INVENTION

One or more example embodiments of the present invention are directed towards a system and/or method for obtaining location of public transportation vehicles using a personal handy-phone system (PHS).

In one embodiment, the method for obtaining location of a public transportation vehicle using a personal handy-phone (PHS) system includes receiving a location request identifying a public transportation vehicle and determining an arrival destination associated with the location request. A response to the location request is generated based on the identified public transportation vehicle and the determined arrival destination. The response may include at least one of a current location of the public transportation vehicle, an estimated time of arrival of the public transportation vehicle at the determined arrival destination, a direction the public transportation vehicle is traveling, and stops of the public transportation vehicle on a route of the public transportation vehicle which are adjacent to the determined arrival destination.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 illustrates an example system for locating public transportation using a PHS;

FIG. 2 is a block diagram showing an example structure of the central station shown in FIG. 1 according to an embodiment of the present invention;

FIG. 3 is a block diagram representing the structure of the location server shown in FIG. 1 according to an example embodiment of the present invention.

FIGS. 4a and 4b illustrate an example embodiment of a method for obtaining the location of public transportation vehicles using a PHS according to the present invention.

### DETAILED DESCRIPTION OF EXAMPLE EMBODIMENTS

Example embodiments of the present invention take advantage of the characteristics of a personal handy-phone system (PHS).

A PHS differs from other the existing cellular type portable communication systems in that the PHS is based on a small zone system. The small zones of the PHS are referred to herein as cells. As such, a PHS provides service to PHS terminals located within a plurality of cells. Each cell includes a repeater and refers to an area around the repeater in which a PHS terminal may communicate with the repeater. A PHS terminal generally uses a relatively weak output of approximately 10 mW, and a repeater generally uses an output of approximately 20 mW in an urban area. Accordingly, a repeater in an urban area may generally service an area of about 100 m in diameter. Obviously, the area serviced by a repeater is largely dependent on the environment of the repeater.

In light of the above, a repeater may be relatively small in size and weight. Therefore, a repeater can easily be installed on a telephone pole or building, for example. Further, the PHS terminal may be relatively small in size and weight, and relatively inexpensive since the transmission output is low compared to other cellular devices.

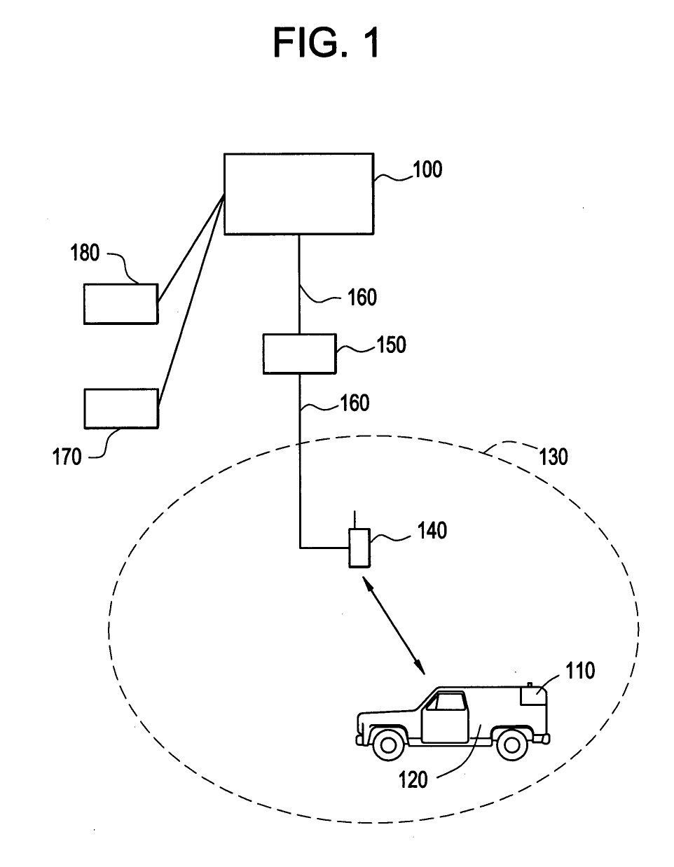

FIG. 1 illustrates an example system for locating public transportation using a PHS. One skilled in the art will appreciate that various details of the example system explained below may vary without departing from the scope of the present invention.

As shown in FIG. 1, the PHS system includes a central station 100 for communicating with a PHS terminal 110. The PHS terminal 110 may be located on a public transportation vehicle such as a bus 120, for example. In FIG. 1, the PHS terminal 110 arranged in the bus 120 are shown as being located within a cell 130. As discussed above, the cell 130 may have a radius of approximately 100 m, which is centered around a repeater 140. In FIG. 1, the repeater 140 is connected to the central station 100 via an exchange station 150. Alternatively, the repeater 140 may be connected directly to the central station 100 or may be connected via a plurality of exchange stations 150. The central station 100, one or more exchange stations 150 and a plurality of repeaters 140 may be connected to each other via communication lines 160.

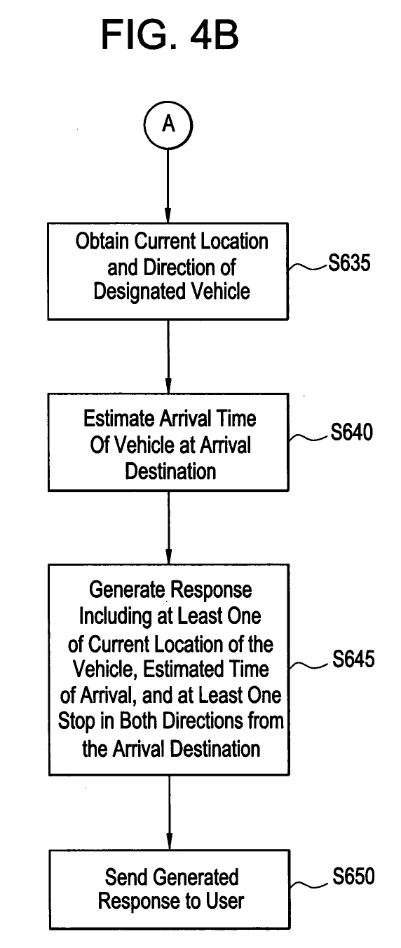

The central station 100 includes and/or is connected to a PHS database 170 and a location server 180 performing a method according to an example embodiment of the present invention, which is described later with respect to FIGS. 4a-4b.

When the central station 100 communicates with the PHS terminal 110 located in the bus 120, location information is stored for the PHS terminal 110 in the PHS database 170. Accordingly, in the example of FIG. 1, when the central station 100 communicates with the PHS terminal 110, the PHS database 170 stores location information indicating that the PHS terminal 110 is located within the cell 130 of the repeater 140. It is noted that the term “communicates” in this application is not limited to establishing conversation. For example, the communication may be only the necessary communication for establishing the location of the PHS terminal 110. Further, it is also noted that when the PHS terminal 110 enters a new cell 130, the location information of the PHS terminal 110 is stored in the PHS database 170. As such, according to example embodiments of the present invention, the location of the PHS terminal 110 may be stored in the database 170 each time the central station 100 communicates with the PHS terminal 110 and each time the PHS terminal 110 enters a new cell 130.

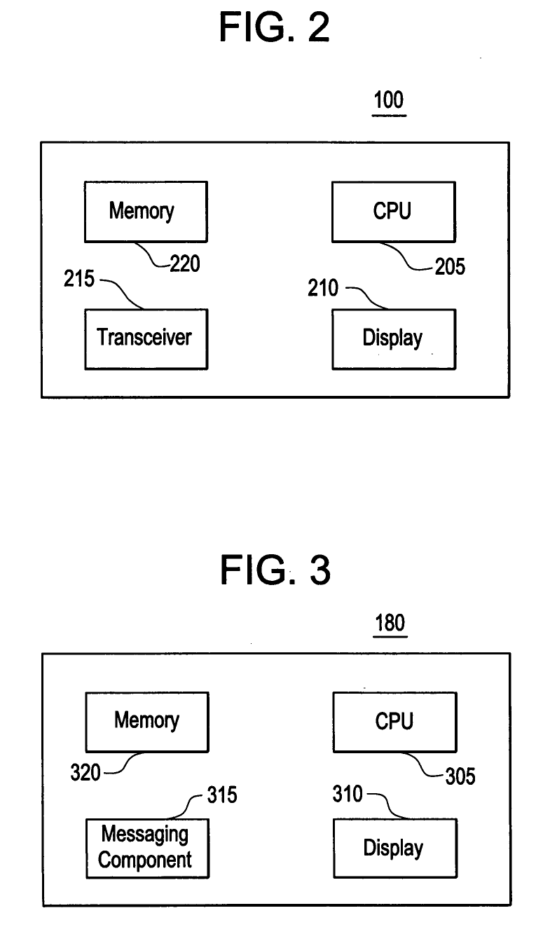

FIG. 2 is a block diagram showing an example structure of central station 100. In FIG. 2, the central station 100 includes a central processing unit (CPU) 205, a display 210, memory 220, and an transceiver 215. The central station 100 is connected to the location server 180 and the PHS database 170 mentioned above. The CPU 205 controls and performs the processes of the central station. The display 210 is connected to the CPU 205 and displays the position of the PHS terminal 110 on a map, for example. The memory 220 stores programs defining operation of central station 100. A transceiver 215 provides an interface with external devices, such as the repeaters 140, PHS terminals 110 and exchange stations 150.

Emitting a signal to search for the position of the PHS terminal 110 and receiving position information of the PHS terminal 110 is described below with respect to FIGS. 1-2. A number of the PHS terminals 110 are dialed by the transceiver 215 of the central station 100. Accordingly, a communication link is established via the exchange station 150 and the repeater 140 corresponding to the cell 130 in which the PHS terminal 110 is located, as shown in FIG. 1. When the communication link is established between the central station 100 and the PHS terminal 110, an ID of the relevant repeater 140 is recognized. Because this recognition only takes a short amount of time, the connection between the central station 100 and the PHS terminal 110 may only be maintained for a short amount of time. Further, because the repeater 140 only services a small zone, the location of the PHS terminal 110 is identified as located within the area of the cell 130 corresponding to the repeater 140. The location of the PHS terminal 110 is then stored in the PHS database 170.

Further, the entry of a PHS terminal 110 into the cell 130 of the repeater 140 causes the position information of the PHS terminal 110 to be recognized and stored in the PHS database 170.

Because the PHS terminal 110 according to an example embodiment of the present invention does not have to support voice communications between the central station 100 and the PHS terminal 110 via the repeater 140, the PHS terminal 110 does not necessarily have to be a fully functional PHS terminal 110. Only the function of communicating with the repeater 140 is required. As such, identification of the repeater 140 corresponding to the cell 130 in which PHS terminal 110 is located is effected using a control channel of the PHS. Therefore, a numerical pad, display, speaker, microphone, and related electronic circuit components may be omitted from the PHS terminal 110. Accordingly, the cost of the PHS terminals 110 located in the public transportation vehicles may be further reduced.

Although a conventional PHS communication device can be used as the PHS terminal 110 according to an example embodiment of the present invention, a reduced PHS terminal, which does not include the numerical pad, display, speaker, and microphone can also be used as the PHS terminal 110 in an example embodiment of the present invention.

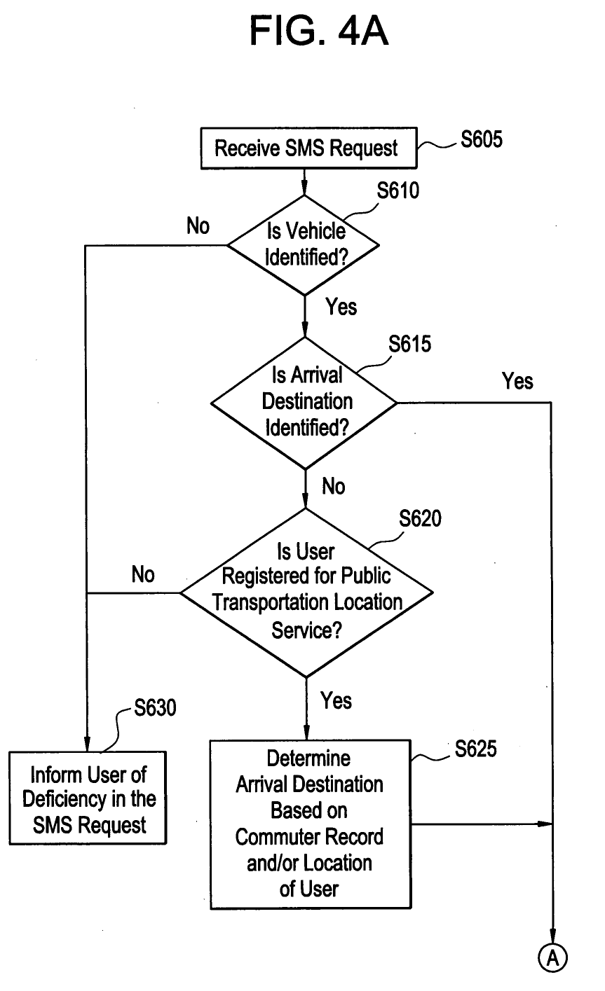

FIG. 3 is a block diagram representing the structure of the location server 180 according to an example embodiment of the present invention.

As shown in FIG. 3, the location server 180 includes a CPU 305, a display 310, memory 320, and a messaging component 315. The location server 180 receives location requests from users, processes the location requests, generates responses to the location requests, and transmits the responses back to the users.

The CPU 305 controls and performs processes relating to receiving and processing location requests and processes relating to generating and transmitting the responses to the requests.

The display 310 displays information. For example, the display 310 of the location server 180 may display the position of the PHS terminal 110 on the bus 120 on a map, for example.

The memory 320 stores programs defining operation of the location server 180 as well data used in the programs. According to an example embodiment of the present invention, the memory 320 of the location server 180 includes a list of the stops on the routes of the public transportation vehicles. Accordingly, the list of stops for a public transportation vehicle identified in a location request can be used in combination with position information of the public transportation vehicle identified in the location request to generate a response to the request, which is described in greater detail later with respect to FIGS. 4a-4b. Still further, the memory 320 may include records for commuters. The records may include commuter information, information about the commuter's communication device, response format preferences, default arrival destinations, and default public transportation vehicles. The default arrival destinations and default public transportation vehicle may represent the arrival destinations and public transportation vehicles used by the commuter.

The messaging component 315 provides an interface with external devices, such as user communication devices, the central station 100 and the PHS database 170. One example of a messaging component 315 of the location server 180 is a voice mail system (“VMS”), such as an AnyPath™® Messaging System offered by Alcatel-Lucent Technologies Inc. The VMS provides conventional voice mail services for the mobile stations. The VMS also provides a short message service (SMS) and thus, sends and receives SMS messages.

Location requests are received from various users and commuters. Location requests may be transmitted to the central station 100 and/or location server 180 using a variety of communication devices including, but not limited to, a personal computer, personal digital assistant (PDA) and mobile telephone, such as a PHS terminal. The location request may be in the form of a SMS request, a website submission, or a voice call to an operator of the central station 100 and/or the location server 180.

According to an example embodiment of the present invention, the location request may be a SMS request including a public transportation vehicle and an arrival destination. For example, if a commuter wants to know when bus 9 will reach the main street stop, the commuter may send the following SMS request “bus 9, main” to be processed by the location server 180.

According to another example embodiment of the present invention, a commuter has a compatible PHS terminal 110 and registers for the public transportation location service provided by the location server 180. By having a compatible PHS terminal 110 and registering for the public transportation location service, the central station 100 may track the location of the user in the same manner in which the PHS terminal 10 located on the bus 120 is tracked, which was previously described. Accordingly, in this example the commuter may send the following SMS request “bus 9” to be processed by the location server 180.

According to still another example embodiment of the present invention, if and when a commuter registers for the public transportation location service provided by the location server 180, the commuter may preset arrival destinations, which may be stored in the memory 320 of the location server. These preset arrival destinations will be used by the location server 180 if the commuter fails to specify an arrival destination in a transmitted location request. For example, the commuter may choose to use the arrival destination closest to the commuter's home as a default arrival destination.

To take advantage of the above described system for obtaining locations of public transportation vehicles using a PHS, before a commuter leaves his/her home to wait at a bus stop, the commuter sends a location request to the central station 100 and/or the location server 180. If the location request is sent to the central station 100, the central station 100 may automatically forward the location request to the location server 180. Alternatively, the location server 180 may receive the location request directly from the commuter's communication device.

FIGS. 4a and 4b illustrate an example embodiment of a method for obtaining the location of public transportation vehicles using a PHS, which is performed at the location server 180.

Referring to FIG. 4a, the messaging component 315 of the location server 180 receives a SMS location request from a commuter's communication device in step S605. As described before, a commuter before going to a public transportation vehicle stop may request location information about the public transportation vehicle the commuter is using. This request may be received by the location server 180 directly from the commuter's communication device or the request may be forwarded from the central station 100.

In step S610, the location server 180 begins processing the received SMS location request by determining if the SMS location request identifies a public transportation vehicle. For example, if the SMS location request is “bus 9” or “bus 9, main”, which were used in previous examples, the location server 180 recognizes that the commuter has identified a public transportation vehicle. In particular, the commuter is requesting information for bus 9.

As shown in FIG. 4a, if the SMS location request identifies a public transportation vehicle the method proceeds to step S615, whereas if the SMS location request does not identify a public transportation vehicle, the method proceeds to step S630 and the commuter is informed that the SMS location request is unacceptable because a public transportation vehicle is not identified. For example, in step S630, the CPU 305 of the location server 180 may generate a response such as “what vehicle?”, for example, and the messaging component 315 of the location server 180 may send the generated response to the commuter.

In step S615, the CPU 305 of the location server 180 processes the received SMS location request to determine if an arrival destination is identified in the SMS location request. For example, the request “bus 9, main” identifies the main street stop as the arrival destination, whereas the example request “bus 9” does not specify an arrival destination in the request. If the SMS location request includes an arrival destination, the method proceeds to step S635, which is described later with respect to FIG. 4b. Alternatively, the method proceeds to step S620, if an arrival destination is not specified in the SMS location request. The determination shown by step S615 is performed by the CPU 305 of the location server 180.

As mentioned before, if the commuter is registered for the public transportation location service, the location server 180 may obtain the location of the commuter in a manner similar to the manner in which the location of public transportation vehicles are located and/or use a default arrival destination specified by the commuter when the commuter registers for the public transportation location service. Accordingly, if an arrival destination is not specified, the CPU 305 of the location server 180 determines if the commuter is registered for the public transportation service in step S620.

In step S620, to determine if the commuter is registered, the location server 180 may store a list of identifiers (e.g., phone numbers, email addresses, etc.) representing registered commuters in the memory 320 of the location server 180. As such, the CPU 305 of the location server 180 may compare the identifier of the user the SMS location request is received from with the list of identifiers stored in the memory 320 of the location server 180. If the identifier of the user the SMS location request is received from corresponds to an identifier included in the memory 320 of the location server 180, the CPU 305 of the location server 180 determines that the commuter sending the SMS location request is registered and the method proceeds to step S625. However, if the identifier of the user the SMS location request is received from does not correspond to an identifier included in the memory 320 of the location server 180, the method proceeds to step s630, because an arrival destination was not specified in the SMS location request and the user is not registered.

In step S630, the location server 180 informs the commuter that the SMS location request cannot be processed. For example, the CPU 305 of the location server generates a response and the messaging component 315 of the location server 180 sends the generated response informing the user that a public transportation vehicle stop was not specified in the SMS location request.

In step S625, the CPU 305 of the location server 180 determines the arrival destination based on a default set during the commuter's registration and/or the current location of the commuter determined in a manner similar to the manner of determining the location of the public transportation vehicle, which was described above. For example, the CPU 305 of the location server 180 may selects an arrival destination on the route of the identified public transportation vehicle, which is closest to the location of the commuter. Once an arrival destination for a registered commuter is determined based on the commuter record and/or location of the user, the method proceeds to step S635 in FIG. 4b.

Referring to FIG. 4b, in step S635, the CPU 305 of the location server 180 obtains the current location and direction of the public transportation vehicle identified in the SMS location request received by the messaging component of the location server 180. As described above, to make this determination, the CPU 305 may request location information from the PHS database 170, which stores the location of the PHS terminals 110. For example, if the commuter requests information for the bus 120, the CPU 305 obtains location information from the PHS database 170 for the bus 120. The CPU 305 of the location server 180 then compares the obtained location information with the list of stops on the route of the bus 120. It is also noted that by obtaining the last two locations for the bus 120 stored in the PHS database, the CPU 305 can determine the direction that the bus 120 is traveling. Once the CPU 305 determines the current location and direction of the public transportation vehicle identified in the SMS location request, the method proceeds to step S640.

In step S640, the CPU 305 estimates the arrival time of the vehicle at the arrival destination. According to an example embodiment of the present invention, this estimation may be based on the number of stops, the distance, the average speed, the average time between stops, etc. For example, if the bus generally takes five minutes between stops and the current location of the bus 120 is three stops from the arrival destination as determined based on the list of stops included in the memory 320, the CPU 305 may estimate the arrival time to be 15 minutes from a current time. Once the estimated arrival time is determined in step S640, the method proceeds to step S645.

In step S645, the CPU 305 generates a response to the SMS location request to the commuter. According to example embodiments of the present invention, the response includes at least one of the current location of the identified public transportation vehicle and estimated arrival time of the identified public transportation vehicle at the arrival destination. Still further, the request message may identify at least one stop in both directions. This information is useful because some public transportation vehicles identify the next stop, and thus, the stop information included in the response message may be used by the commuter to ensure that the commuter is using a public transportation vehicle traveling in the correct direction.

The generated response is then sent to the commuter by the messaging component 315 in step S650. Based on the information included in the generated response, the commuter can plan accordingly, thereby decreasing wait time at the arrival destination.

Example embodiments of the present invention being thus described, it will be obvious that the same may be varied in many ways. Such variations are not to be regarded as a departure from the invention, and all such modifications are intended to be included within the scope of the invention.

What is claimed:

1. A method for obtaining location of a public transportation vehicle using a personal handy-phone (PHS) system, the method comprising:
receiving a location request identifying a public transportation vehicle;
determining an arrival destination associated with the location request; and
generating a response to the location request based on the identified public transportation vehicle and the determined arrival destination, the response including at least one of a current location of the public transportation vehicle, an estimated time of arrival of the public transportation vehicle at the determined arrival destination, a direction the public transportation vehicle is traveling, and stops of the public transportation vehicle on a route of the public transportation vehicle which are adjacent to the determined arrival destination.

2. The method of claim 1, wherein at least one of the location request and the generated response is a short message service (SMS) location request.

3. The method of claim 1, wherein
the location request also identifies an arrival destination associated with the request; and
the determining step determines the identified arrival destination as the determined arrival destination.

4. The method of claim 1, wherein the determining step comprises:
using the arrival destination identified in the location request if the location request includes the arrival destination; and wherein
the generating step generates the response based on the arrival destination and the identified public transportation vehicle identification.

5. The method of claim 1, wherein the determining step comprises:
ascertaining if a requesting party that sent the location request is a registered party for a location request service if an arrival destination is not identified in the location request;
obtaining a record associated with the requesting party if the ascertaining step ascertains that the requesting party is a registered party; and
determining a default arrival destination included in the record as the determined arrival destination.

6. The method of claim 1, wherein the determining step comprises:
ascertaining if a requesting party that sent the location request is a registered party for a location request service if an arrival destination is not identified in the location request;
detecting a location of the requesting party based on position information of a communication device used by the requesting party; and
selecting an arrival destination based on the position information of the communication device as the determined arrival destination.

7. The method of claim 1, wherein the generating step comprises
obtaining position information of a PHS terminal included in the public transportation vehicle, the position information including a current location of the PHS terminal; and
using the current location of the PHS terminal as the current location of the public transportation vehicle in the response.

8. The method of claim 1, wherein the generating step comprises
obtaining position information of a PHS terminal included in the public transportation vehicle, the position information including a current location of the PHS terminal and at least one previously recorded location of the PHS terminal;
comparing the current location of the PHS terminal with the at least one previously recorded location of the PHS terminal;
determining a direction of travel of the PHS terminal based on the comparing step; and
using the direction of travel of the PHS terminal as the direction the public transportation vehicle is traveling in the response.

9. The method of claim 1, wherein the generating step comprises:
obtaining position information of a PHS terminal included in the public transportation vehicle, the position information including a current location of the PHS terminal;
determining the estimated time of arrival of the public transportation vehicle at the arrival destination based on the current location of the PHS terminal and at least one of a number of stops between the arrival destination and the current location of the PHS terminal, a distance between the arrival destination and the current location of the PHS terminal, an average speed of the public transportation vehicle, and an average time between adjacent stops of the public transportation vehicle; and
generating the response to include the estimated time of arrival.

10. The method of claim 1, further comprising:
sending the generated response to a party from which the location request was received.

11. A personal handy-phone (PHS) system for obtaining a location of public transportation vehicles, the PHS system comprising:
a plurality of PHS terminals included in the public transportation vehicles;
a PHS database storing position information of the plurality of PHS terminals; and
an location server receiving a location request identifying a public transportation vehicle, determining an arrival destination associated with the location request, and generating a response to the location request based on the identified public transportation vehicle and the determined arrival destination, the response including at least one of a current location of the identified public transportation vehicle, an estimated time of arrival of the identified public transportation vehicle at the determined arrival destination, a direction the identified public transportation vehicle is traveling, and stops of the identified public transportation vehicle on a route of the identified public transportation vehicle which are adjacent to the determined arrival destination.

12. The PHS system of claim 11, wherein the location server comprises:
a memory storing a list of the stops on each route of the public transportation vehicles, a list of identifiers associated with parties registered for a location request service provided by the location server and records of the registered communication devices;
a messaging component receiving the location request identifying the public transportation vehicle, and receiving position information for the PHS terminal of the identified public transportation vehicle from the PHS database; and
a central processing unit (CPU) determining the determined arrival destination, and generating the response based on the determined arrival destination and the identified public transportation vehicle.
